(19) United States
(12) Patent Application Publication
(10) Pub. No.: US 2011/0026482 A1
(43) Pub. Date: Feb. 3, 2011

(54) METHOD AND APPARATUS FOR PILOT SIGNAL TRANSMISSION

(75) Inventors: Jianjun Li, Gyeonggi-Do (KR); Jung Nam Yun, San Jose, CA (US); Zhengzi Li, Gyeonggi-Do (KR); Dong Jun Lee, Seoul (KR); Jae Hyeong Kim, Seoul (KR)

Correspondence Address: BLANK ROME LLP, WATERGATE, 600 NEW HAMPSHIRE AVENUE, N.W., WASHINGTON, DC, 20037, US

(73) Assignee: Postdata Co., Ltd., Seongnam-si, Kyeonggi-do (KR)

(21) Appl. No.: 12/934,932

(22) PCT Filed: Dec. 26, 2008
(86) PCT No.: PCT/KR09/01555

§ 371 Date: Sep. 27, 2010

Related U.S. Application Data
(60) Provisional application No. 61/040,144, filed on Mar. 27, 2008.
(60) Provisional application No. 61/040,145, filed on Mar. 27, 2008.
(60) Provisional application No. 61/094,620, filed on Sep. 5, 2008.

(30) Foreign Application Priority Data
Mar. 25, 2009 (KR) 10-2009-0025417

(51) Int. Cl. H04W 74/02

(52) U.S. Cl. 370/329

(57) ABSTRACT

A method and apparatus for pilot signal transmission is disclosed, which is capable of improving efficiency in a wireless communication system, the method comprising transmitting an uplink transmission frame for a first sector or cell by a mobile station through the use of basic pilot pattern in a resource block and transmitting an uplink transmission frame for a second sector or cell by the mobile station through the use of shift pilot pattern which is not overlapped with the basic pilot pattern in the resource block.

### TECHNICAL FIELD

The present invention relates to a wireless communication system, and more particularly, to a method for a pilot signal transmission in a wireless communication system.

### BACKGROUND ART

IEEE (Institute of Electrical and Electronics Engineers) 802 Committee plans on developing a technology standard of IEEE 802.16m, wherein IEEE 802.16m, which is ahead of a current mobile WiMAX, is highly regarded as a next-generation technology of Wibro/Mobile WiMAX. IEEE 802.16m aims at realizing data-transmission amount of 100 Mbps under a mobile state, and data-transmission amount of 1 Gbps under an immobile state.

Under a wireless communication system based on IEEE 802.16m, in the same way as related art IEEE 802.16e, a mobile station or base station has to perform a channel estimation so as to restore information data transmitted from the base station or mobile station. This channel estimation is performed using a pilot. The pilot is a signal component which corresponds to a base for estimating a channel state in a wire or wireless communication system. When a radio wave is transmitted through an unknown channel, a predetermined sequence is transmitted, which is known to both the base station and mobile station.

In a wireless communication network based on IEEE 802.16m, the pilot is used for the channel estimation. Thus, there has been proposed a variety of pilot patterns being usable for the wireless communication network based on IEEE 802.16m. However, if the proposed pilot patterns for a downlink sub-frame are applied under a multi-cell environment, every cell or sector uses the same pilot pattern so that it has a disadvantage of interference among the cells or sectors. Also, when boosting the pilots, it is difficult for the related art pilot pattern to realize high performance for every pilot.

In case of the pre-proposed pilot pattern, even though data for some sectors is not fully loaded, the pilots are always in a full-loading state. Thus, it has a problem that SINR (Signal to Interference Noise Ratio) of pilot symbols can not be improved by data symbols.

Also, in case of the related art pilot pattern for MIMO system, since the pilots for a specific antenna are not uniformly distributed in one bin, it is difficult to realize an optimized channel estimation performance.

In the meantime, in case of a related art pilot pattern for an uplink sub-frame, proposed for IEE 802.16m, since it is boosted by the pilot number per symbol, power is wasted due to the pilot. Furthermore, the plurality of pilots are not positioned at the same sub-carrier, it may cause a problem of complexity in CFO (Carrier Frequency Offset) computation.

Like the pilot pattern for the downlink sub-frame, the pilot pattern for the uplink sub-frame, proposed for IEEE 802.16m, is designed without consideration for interference among cells or sectors, whereby it has a disadvantage of interference among the cells or sectors. This problem becomes more serious when performing SM (Spatial Multiplexing). Especially, in considering that the pilot is boosted for improvement of the channel estimation performance, if the pilots collide with one another, it has a problem that interference is bigger than data.

### DISCLOSURE OF INVENTION

### Technical Problem

Therefore, the present invention has been made in view of the above problems, and it is an object of the present invention to provide a method and apparatus for pilot signal transmission, which is capable of preventing one or more problems of the related art.

Another object of the present invention is to provide a method and apparatus for pilot signal transmission, which is capable of improving efficiency in a wireless communication system.

Another object of the present invention is to provide a method and apparatus for pilot signal transmission, which is capable of mitigating interference among cells or sectors.

A further object of the present invention is to provide a method and apparatus for pilot signal transmission, which is capable of uniformly distributing pilots per each antenna in a wireless communication system supporting MIMO.

### Technical Solution

To achieve these objects and other advantages and in accordance with the purpose of the invention, as embodied and broadly described herein, a method for a pilot signal transmission comprises transmitting an uplink transmission frame for a first sector or cell by a mobile station through the use of basic pilot pattern in a resource block and transmitting an uplink transmission frame for a second sector or cell by the mobile station through the use of shift pilot pattern which is not overlapped with the basic pilot pattern in the resource block.

In another aspect of the present invention, a method for a pilot signal transmission comprises transmitting an uplink transmission frame by a first mobile group in a sector or cell through the use of basic pilot pattern in a resource block and transmitting an uplink transmission frame by a second mobile group in the sector or cell through the use of shift pilot pattern in the resource block, wherein the shift pilot pattern is obtained by shifting the basic pilot pattern in at least one of the symbol axis and sub-carrier axis directions.

In another aspect of the present invention, a method for a pilot signal transmission comprises forming a transmission frame including at least one resource block in which pilots are allocated so that each of cells or sectors have different pilot patterns, and the same PRBS for a macro diversity band to transmit the transmission frame and forming a transmission frame including at least one resource block in which pilots are allocated so that each of cells or sectors have different pilot patterns, and different PRBSs for a normal band to transmit the transmission frame.

In another aspect of the present invention, a method for a pilot signal transmission comprises generating a transmission frame including at least one resource block in which pilots with a first pilot pattern and data are arranged for a first cell or sector; and transmitting the transmission frame to a mobile station, wherein the first pilot pattern is not overlapped with a second pilot pattern for a second cell or sector.

In another aspect of the present invention, a method for a pilot signal transmission comprises generating a second pilot pattern while being not overlapped with a first pilot pattern; and allocating a pilot or pilot set in a downlink sub-frame for a first sector through the use of the first pilot pattern, and allocating a pilot or pilot set in a downlink sub-frame for a second sector through the use of the second pilot pattern.

In another aspect of the present invention, an apparatus for a pilot signal transmission comprises means for forming a transmission frame including at least one resource block whose pilots and data are allocated such that a first pilot pattern for a first cell or sector is not overlapped with a second pilot pattern for a second cell or sector; and transmission means for transmitting the transmission frame to a mobile station.

### ADVANTAGEOUS EFFECTS

According to the present invention, the method and apparatus for pilot signal transmission according to the present invention has the following advantages.

Since the pilot pattern is differently uses by each sector or cell, it is possible to mitigate interference among the sectors or cells.

The mitigation of interference among the sectors or cells can improve the efficiency of wireless communication system.

When boosting the pilots, the channel estimation can be realized with the high reliability for every pilot.

Also, if the present invention is applied to the wireless communication system supporting MIMO, the pilot position is uniformly distributed per each antenna, thereby resulting in the improved channel estimation performance.

Also, the mitigation of interference among the sectors or cells and accuracy in estimation of carrier offset and channel estimation can be realized owing to the proposed pilot pattern which can reduce the pilot number per each symbol.

### BRIEF DESCRIPTION OF DRAWINGS

FIG. 1 illustrates pilot patterns applied to a downlink sub-frame for each sector under a MIMO system according to one embodiment of the present invention;

FIGS. 2 to 4 illustrate pilot patterns applied to a downlink sub-frame for each sector under a MIMO system according to another embodiment of the present invention;

FIGS. 5 and 6 illustrate pilot patterns applied to a downlink sub-frame for each sector under an SISO system according to one embodiment of the present invention;

FIG. 7 illustrates an exemplary usage of pilot pattern; and

FIGS. 8 to 11 illustrate pilot patterns applied to an uplink sub-frame for each sector under a MIMO system according to the first to fourth embodiments of the present invention.

### MODE FOR THE INVENTION

Reference will now be made in detail to the preferred embodiments of the present invention, examples of which are illustrated in the accompanying drawings. Wherever possible, the same reference numbers will be used throughout the drawings to refer to the same or like parts.

Hereinafter, method and apparatus for pilot signal transmission according to the present invention will be described with reference to the accompanying drawings.

Before explaining the present invention, terms used for the present invention, for example, a sector, a cell, and a base station, will be defined in brief. Generally, the plurality of base stations exist in a wireless network, wherein each base station provides coverage for a predetermined area referred to as the cell. If one cell is divided into the sectors, each sector can be regarded as the cell in view of system technology. For the following description of the present invention, “cell” and “sector” are compatible with each other, and “cell” or “sector” can be expressed as other terms for the base station.

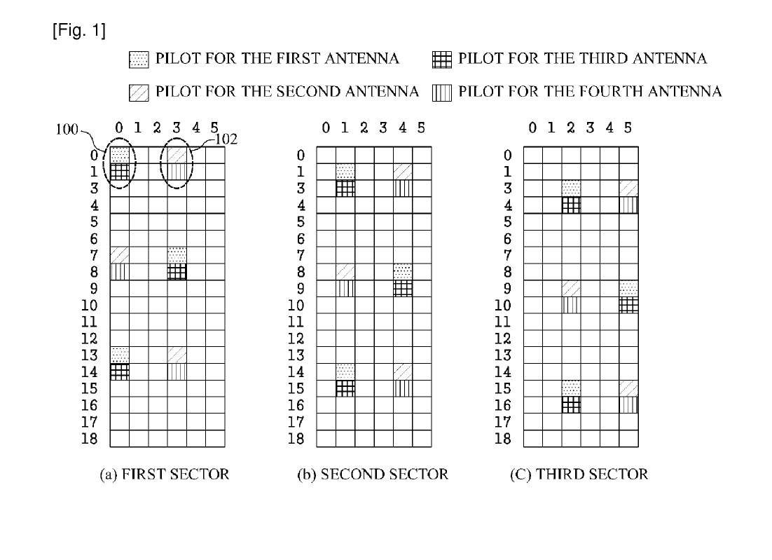

First, a method for allocating a pilot for a downlink sub-frame of each sector according to the present invention will be explained with reference to FIGS. 1 to 3.

FIG. 1 shows a pilot pattern per each sector according to one embodiment of the present invention. In this case, pilot patterns shown in FIG. 1 correspond to pilot patterns which can be applied to a basic allocation unit in the downlink sub-frame under an MIMO (Multi Input Multi Output) system. Supposing the basic allocation unit is a resource block, for convenience of the explanation. In one embodiment of the present invention, the resource block may be 18 sub-carriers by 6 OFDMA symbols.

In case of the pilot patterns proposed in IEEE 802.16m, each sector or each cell uses the same pilot pattern under a multi-cell environment, whereby interference occurs between the cells or sectors. In order to mitigate the interference between the cells or sectors, the present invention proposes that each sector or each cell does not use the same pilot pattern but use the different pilot patterns having the different forms while maintaining the same property, as shown in FIG. 1. That is, each sector or each cell of the present invention uses the pilot patterns which are non-overlapping with one another, to thereby mitigate the interference between the sectors or cells.

The embodiment of FIG. 1 is explained on the assumption that it is applied so as to mitigate the interference among the three sectors constituting one cell. However, it is not limited to this, that is, the present invention can be applied to mitigate the interference between the two sectors or among the three or more sectors, and furthermore, between or among base stations.

The method for pilot signal transmission according to the present invention firstly determines a basic pilot pattern, and generates other pilot patterns by cyclically shifting the basic pilot pattern, so that the different pilot patterns are applied by each sector. When generating the other pilot patterns by cyclically shifting the basic pilot pattern, only the form of the basic pilot pattern is changed while maintaining the property of the basic pilot pattern.

That is, the basic pilot pattern (hereinafter, referred to as ‘first pilot pattern’) is applied to the resource block of the downlink sub-frame for any one sector (hereinafter, referred to as ‘first sector’) among the three sectors, and the other pilot patterns (hereinafter, referred to as ‘second pilot pattern’ and ‘third pilot pattern’) are respectively applied to the resource blocks of the downlink sub-frames for the remaining two sectors (hereinafter, referred to as ‘second sector’ and ‘third sector’).

In one embodiment of the present invention, the second and third pilot patterns can be generated by cyclically shifting the pilots of the first pilot pattern along at least one of the symbol index and sub-carrier index in a frame by a predetermined value. For example, the second pilot pattern is generated by shifting the pilot position of the first pilot pattern in the sub-carrier index direction by Δf and in the symbol index direction by ΔT. The third pilot pattern is generated by shifting the pilot position of the first pilot pattern in the sub-carrier index direction by 2Δf and in the symbol index direction by 2ΔT.

Hereinafter, the pilot patterns according to the present invention will be explained with reference to FIG. 1.

FIG. 1 illustrates the first to third pilot patterns when Δf is ‘1’ and ΔT is ‘1’. Herein, it is shown that the pilots for four transmission antennas or four transmission streams are allocated in one resource block.

At this time, the resource block means an area which is 18 sub-carriers by 6 symbols.

First, FIG. 1(a) illustrates the first pilot pattern. As shown in FIG. 1(a), each first pilot set 100 is allocated to the sub-carrier indexes 0 and 1 at the OFDMA symbol index 0, the sub-carrier indexes 12 and 13 at the OFDMA symbol index 0, and the sub-carrier indexes 6 and 7 at the OFDMA symbol index 3, wherein each first pilot set 100 is comprised of a pilot for the first antenna or first stream, and a pilot for the third antenna or third stream. Also, each second pilot set 102 is allocated to the sub-carrier indexes 6 and 7 at the OFDMA symbol index 1, the sub-carrier indexes 0 and 1 at the OFDMA symbol index 3, and the sub-carriers indexes 12 and 13 at the OFDMA symbol index 3, wherein each second pilot set 102 is comprised of a pilot for the second antenna or second stream, and a pilot for the fourth antenna or fourth stream. As mentioned above, the first pilot pattern is applied for the resource block of the downlink sub-frame for the first sector.

Next, FIG. 1(b) illustrates the second pilot pattern, wherein the second pilot pattern can be generated by shifting the pilot position of the first pilot pattern shown in FIG. 1(a) in the increasing sub-carrier index direction by one sub-carrier index, and in the increasing symbol index direction by one symbol index.

In the second pilot pattern, each first pilot set 100 is allocated to the sub-carrier indexes 1 and 2 at the OFDMA symbol index 1, the sub-carrier indexes 13 and 14 at the OFDMA symbol index 1, and the sub-carrier indexes 7 and 8 at the OFDMA symbol index 4. Also, each second pilot set 102 is allocated to the sub-carrier indexes 7 and 8 at the OFDMA symbol index 2, the sub-carrier indexes 1 and 2 at the OFDMA symbol 4, and the sub-carrier indexes 13 and 14 at the OFDMA symbol 4. As mentioned above, the second pilot pattern is applied for the resource block of the downlink sub-frame for the second sector.

FIG. 1(c) illustrates the third pilot pattern, wherein the third pilot pattern can be generated by shifting the pilot position of the first pilot pattern shown in FIG. 1(a) in the increasing sub-carrier index direction by two sub-carrier indexes, and in the increasing symbol index direction by two symbol indexes.

In the third pilot pattern, each first pilot pattern 100 is allocated to the sub-carrier indexes 2 and 3 at the OFDMA symbol index 2, the sub-carrier indexes 14 and 15 at the OFDMA symbol index 2, and the sub-carrier indexes 8 and 9 at the OFDMA symbol index 5. Also, each second pilot set 102 is allocated to the sub-carrier indexes 8 and 9 at the OFDMA symbol index 3, the sub-carrier indexes 2 and 3 at the OFDMA symbol index 5, and the sub-carrier indexes 14 and 15 at the OFDMA symbol index 5. As mentioned above, the third pilot pattern is applied for the resource block of the downlink sub-frame for the third sector.

The aforementioned embodiment of the present invention discloses the resource block which is 18 sub-carriers by 6 OFDMA symbols. However, the size of resource block may be variable. Also, the aforementioned embodiment of the present invention discloses that the first pilot pattern corresponds to the basic pilot pattern. However, the second or third pilot pattern may correspond to the basic pilot pattern.

The aforementioned embodiment of the present invention discloses that the pilot position is shifted in both the symbol index and sub-carrier index directions. However, a modified embodiment of the present invention may disclose that the pilot position is shifted in any one of the symbol index and sub-carrier index directions.

Also, the aforementioned embodiment of the present invention discloses that the second pilot pattern is applied for the resource block of the downlink sub-frame for the second sector, and the third pilot pattern is applied for the resource block of the downlink sub-frame for the third sector. However, the second pilot pattern may be applied for the resource block of the downlink sub-frame for the third sector, and the third pilot pattern may be applied for the resource block of the downlink sub-frame for the second sector.

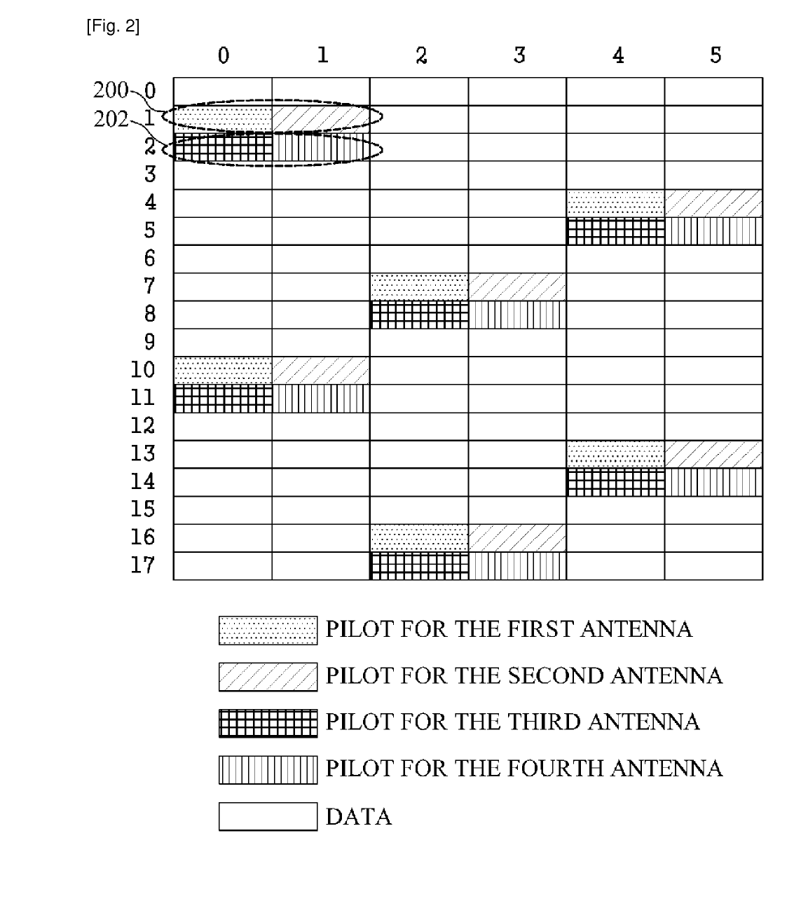

Instead of the basic pilot pattern (first pilot pattern) shown in FIG. 1(a), a pilot pattern shown in FIG. 2 may be used as the basic pilot pattern. FIG. 2 shows the pilot pattern which can be applied in an MIMO system having four transmission antennas or four transmission streams in Band AMC. Hereinafter, supposing each pilot is for four transmission antennas for convenience of the explanation.

In FIG. 2, each first pilot set 200 is allocated to the sub-carrier indexes 1 and 10 at the OFDMA symbol indexes 0 and 1, the sub-carrier indexes 7 and 16 at the OFDMA symbol indexes 2 and 3, and the sub-carrier indexes 4 and 13 at the OFDMA symbol indexes 4 and 5, wherein each first pilot set 200 is comprised of a pilot for the first antenna, and a pilot for the second antenna.

Also, each second pilot set 202 is allocated to the sub-carrier indexes 2 and 11 at the OFDMA symbol indexes 0 and 1, the sub-carrier indexes 8 and 17 at the OFDMA symbol indexes 2 and 3, and the sub-carrier indexes 5 and 14 at the OFDMA symbol indexes 4 and 5, wherein each first pilot set 200 is comprised of a pilot for the third antenna, and a pilot for the fourth antenna.

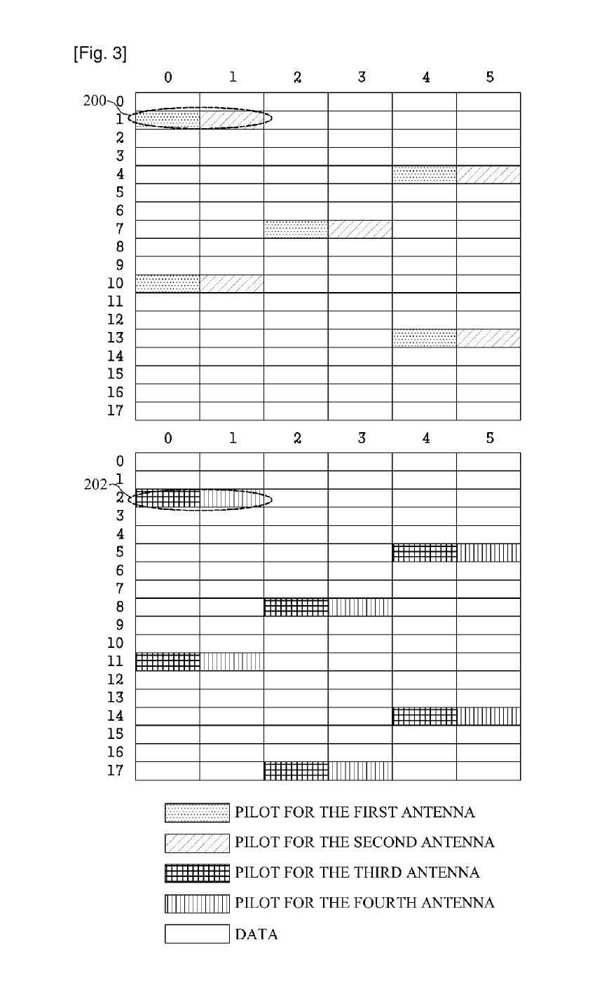

However, in case of using the pilot pattern shown in FIG. 2, the pilot distribution may not be even by each antenna. In more detail, as shown in FIG. 3, if the pilot pattern of FIG. 2 is divided into the pilot pattern for the first and second antennas, and the pilot pattern for the third and fourth antennas, it can be known that the pilots for the third and fourth antennas are positioned at the bottom of the resource block as compared with the pilots for the first and second antennas, whereby the distribution of the pilots for the third and fourth antennas is not even relatively.

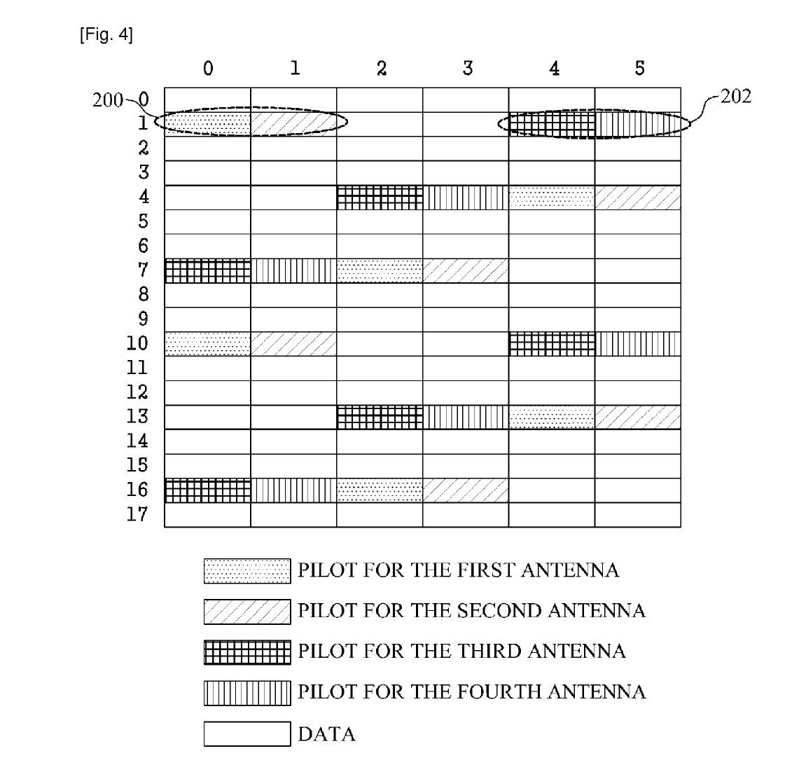

In order to improve channel estimation efficiency by evenly distributing the pilots for each antenna or stream, the basic pilot pattern of FIG. 2 can be changed to that of FIG. 4.

When comparing the pilot pattern of FIG. 4 with the pilot pattern of FIG. 2, it shows that their first pilot sets 200 are identical in position, but their second pilot sets 202 are not identical in position. That is, in comparison to the pilot pattern of FIG. 2, the pilot pattern of FIG. 4 has the changed position of the second pilot set 202. In more detail, as shown in FIG. 4, the position of the second pilot sets 202 is cyclically shifted in the increasing sub-carrier index direction of the resource block by five sub-carrier indexes.

Also, the position of the second pilot sets 202 may be determined by cyclically shifting the first pilot sets 200 in the decreasing OFDMA-symbol index direction by 2 OFDMA symbols, or by cyclically shifting the first pilot sets 200 in the increasing OFDMA-symbol index direction by four OFDMA symbol indexes.

That is, each second pilot set 202 is allocated to the sub-carrier indexes 7 and 16 at the OFDMA symbol indexes 0 and 1, the sub-carrier indexes 4 and 5 at the OFDMA symbol indexes 2 and 3, and the sub-carrier indexes 1 and 10 at the OFDMA symbol indexes 4 and 5.

According as the second pilot set 202 including the pilots for the third and fourth antennas is changed in its position, the second pilot set 202 and the first pilot set 200 can be distributed evenly within one resource block, thereby resulting in the improved channel estimation efficiency.

Although not shown in FIGS. 2 to 4, the changed pilot pattern can be obtained by shifting the pilots in the pilot pattern of FIG. 4 along at least one of the symbol index and sub-carrier index directions by the predetermined value, as explained with reference to FIG. 1, so that the different pilot patterns are used by each sector.

The aforementioned embodiment of the present invention is applied for the MIMO system. A modified embodiment of the present invention can be applied for an SISO (Single Input Single Output) system. Hereinafter, there will be explained a pilot pattern for each sector when the present invention is applied for the SISO system.

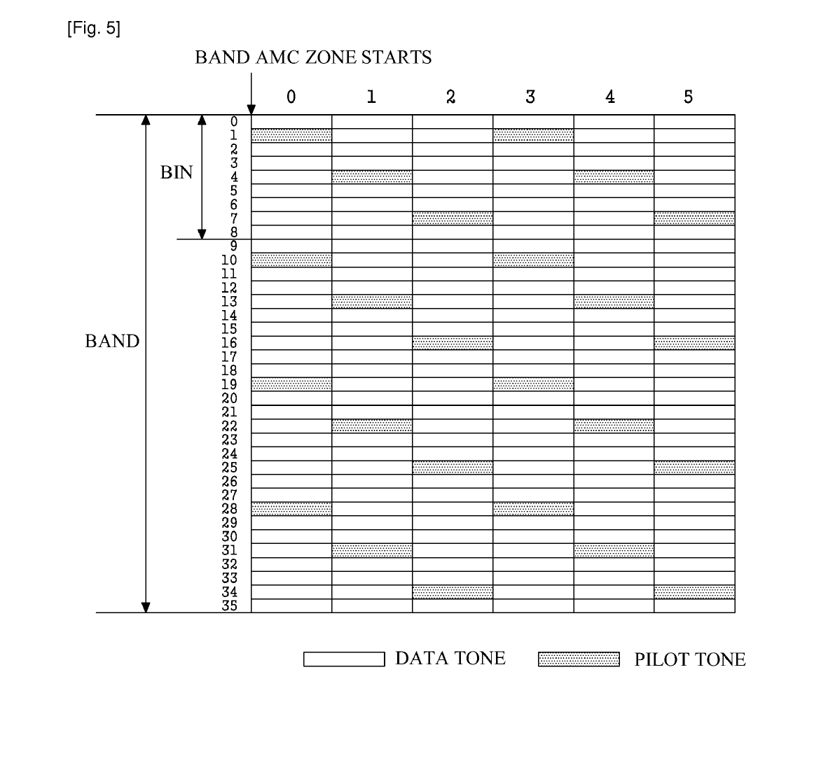

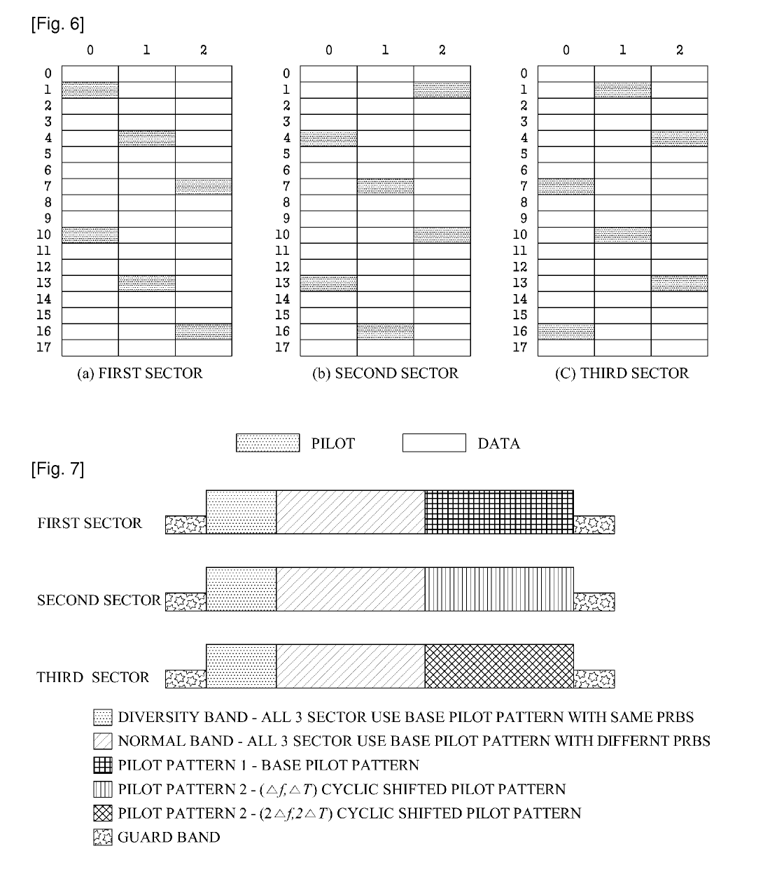

First, the pilot pattern of FIG. 5 shows the pilot pattern in a Band AMC mode. For convenience of explanation, FIG. 5 is explained based on a related art frame structure provided with a basic allocation unit of bin. However, as explained above, the basic allocation unit may be the resource block. In the pilot pattern of FIGS. 5 to 6, the basic allocation unit may be understood as the resource block in consideration of the entire context. Here, the bin is comprised of nine contiguous sub-carriers within one OFDMA symbol, one slot can be defined with two bins by three OFDMA symbols, and two slots can be defined as one resource block. Also, a band is defined with a group of four rows of bins of the pilot pattern, and an AMC sub-channel is comprised of six contiguous bins in the same band.

As shown in FIG. 5, in case of each first pilot pattern corresponding to a basic pilot pattern, the pilots are respectively allocated to the sub-carrier indexes 1, 4, and 7 at the different OFDMA symbol indexes by each bin.

FIG. 6(a) illustrates one slot unit in the first pilot pattern of FIG. 5. As shown in FIG. 6(a), the pilots are allocated to the sub-carrier indexes 1 and 10 at the OFDMA symbol index 0, the sub-carrier indexes 4 and 13 at the OFDMA symbol index 1, and the subcarrier indexes 7 and 16 at the OFDMA symbol index 2 within one slot. The first pilot pattern is used in the resource block of the downlink sub-frame for the first sector.

While using the first pilot pattern of FIG. 6(a) as the basic pilot pattern, the pilots included in the first pilot pattern are cyclically shifted in the sub-carrier index direction by the predetermined value, thereby generating second and third pilot patterns respectively shown in FIG. 6(b) and FIG. 6(c).

In more detail, as shown in FIG. 6(b), it is known that the second pilot pattern is obtained by cyclically shifting the pilots of the first pilot pattern in the increasing OFDMA-symbol index direction by two OFDMA-symbol indexes. That is, the pilots are allocated to the sub-carrier indexes 4 and 13 at the OFDMA symbol index 0, the sub-carrier indexes 7 and 16 at the OFDMA symbol index 1, and the sub-carrier indexes 1 and 10 at the OFDMA symbol index 2 within one slot.

As shown in FIG. 6(c), it is known that the third pilot pattern is obtained by cyclically shifting the pilots of the first pilot pattern in the increasing OFDMA-symbol index direction by four OFDMA-symbol indexes. That is, the pilots are allocated to the sub-carrier indexes 7 and 16 at the OFDMA symbol index 0, the sub-carrier indexes 1 and 10 at the OFDMA symbol index 1, and the sub-carrier indexes 4 and 13 at the OFDMA symbol index 2.

The aforementioned embodiment of the present invention discloses that the position of the pilots is cyclically shifted in the increasing OFDMA-symbol index direction. However, a modified embodiment of the present invention discloses that the pilots are cyclically shifted in the decreasing OFDMA-symbol index direction. That is, the second pilot pattern of FIG. 6(b) is obtained by cyclically shifting the pilots of the first pilot pattern in the decreasing OFDMA-symbol index direction by one OFDMA-symbol index, and the third pilot pattern of FIG. 6(c) is obtained by cyclically shifting the pilots of the first pilot pattern in the decreasing OFDMA-symbol index direction by two OFDMA-symbols indexes.

As mentioned above, the present invention can be applicable to both the MIMO and SISO systems. Each sector uses different pilot patterns whose position in allocation of the pilots is changed while maintaining the structural property of the basic pilot pattern. That is, because a predetermined position on which the pilot is allocated of one sector may be a position on which a data tone is allocated of another sector, it is possible to mitigate the interference between the sectors. If some sectors are not fully loaded, the interference from data signals can be lowered and the channel estimation efficiency of the other sectors can be improved.

FIG. 7 illustrates an exemplary usage of pilot pattern.

According a band used by sector in such a way using the pilot pattern, a basic pilot pattern having the different RPBS (Pseudo Random Binary Sequence) for each sector is used in a normal band, and a pilot pattern having same RPBS for each sector is used in a band applied with macro diversity. Also, each sector may have the different pilot patterns by using the basic pilot pattern and cyclic shifted pilot patterns in the normal band or macro-diversity band.

This method according to the present invention can be applied to both FDM and TDM systems.

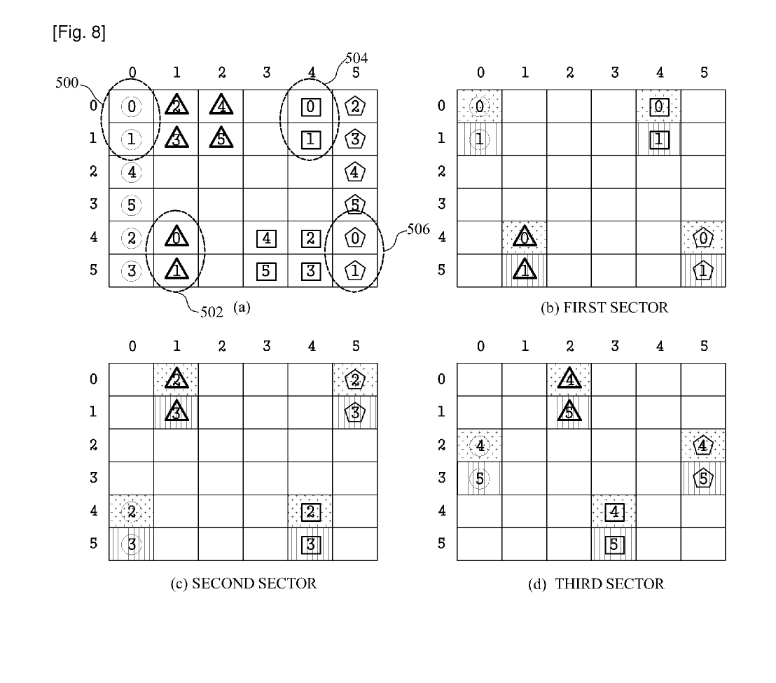

Hereinafter, a method for a pilot allocation for an uplink sub-frame by each sector according to the present invention will be explained with reference to FIGS. 8 to 11.

As mentioned in description of downlink sub-frame, in order to mitigate interference in the uplink sub-frame for each sector, a basic pilot pattern is firstly determined, and then pilots of the basic pilot pattern are shifted so as to generate a different pilot pattern.

Hereinafter, for convenience of explanation, the pilot pattern is explained on the assumption that the resource block is 6 sub-carriers by 6 OFDMA symbols. However, it is not limited to this size, that is, the size of the resource block may be variable.

FIG. 8 illustrates a pilot pattern in the resource block of the uplink sub-frame for each sector according to the first embodiment of the present invention.

First, FIG. 8(a) explains a rule for generating different types of pilot patterns by shifting the basic pilot pattern. In FIG. 8(a), various forms such as a circle, a triangle, a quadrangle, and a pentagon are provided to differentiate each pilot set. Each pilot set is comprised of a pilot for a first antenna or first stream, and a pilot for a second antenna or second stream. Also, the number written in each form expressing each pilot set, for example, “0”, “1”, “2”, “3”, “4”, and “5”, indicates the position-shift order of the pilot sets.

In more detail, a first pilot set 500 positioned at the 0^{th} OFDMA symbol is shifted from the sub-carrier indexes 0 and 1 to the sub-carrier indexes 4 and 5, and then is again shifted to the sub-carrier indexes 2 and 3.

Also, a second pilot set 502 positioned at the OFDMA symbol index 1 is shifted from the sub-carrier indexes 4 and 5 to the sub-carrier indexes 0 and 1, and then is again shifted to the sub-carrier indexes 0 and 1 at the OFDMA symbol index 2.

Also, a third pilot set 504 positioned at the OFDMA symbol index 4 is shifted from the sub-carrier indexes 0 and 1 to the sub-carrier indexes 4 and 5, and then is again shifted to the sub-carrier indexes 4 and 5 at the OFDMA symbol index 3.

Also, a fourth pilot set 506 positioned at the OFDMA symbol index 5 is shifted from the sub-carrier indexes 4 and 5 to the sub-carrier indexes 0 and 1, and then is again shifted to the sub-carrier indexes 2 and 3.

As the pilot sets of the basic pilot pattern shown in FIG. 8(b) are shifted according to this rule, it is possible to generate the pilot patterns shown in FIG. 8(c) and FIG. 8(d). The pilot pattern shown in FIG. 8(c) is generated by shifting the pilot sets of the pilot pattern of FIG. 8(b) one time, and the pilot pattern shown in FIG. 8(d) is generated by shifting the pilots of the pilot pattern of FIG. 8(b) two times.

If the pilot patterns shown in FIG. 8(b) to FIG. 8(d) are different from one another in form, a point of starting the change of pilot pattern may be changed based on at least one criterion.

If the pilots are allocated to the resource blocks of the uplink sub-frames for the first to third sectors according to the pilot patterns shown in FIGS. 8(b) to FIG. 8(d), the different pilot patterns can be respectively used per each sector so that it is possible to mitigate interference among the sectors.

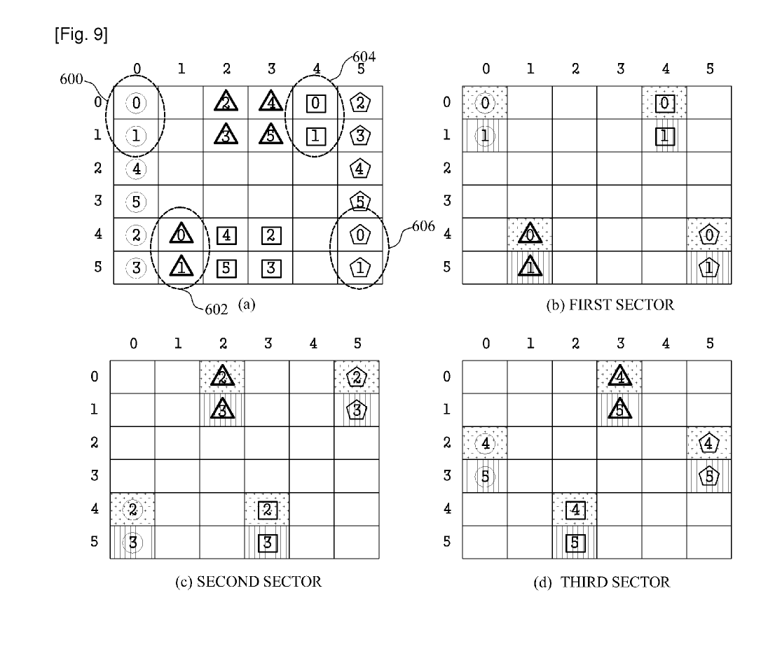

FIG. 9 illustrates a pilot pattern in the resource block of the uplink sub-frame for each sector according to the second embodiment of the present invention.

First, FIG. 9(a) explains a rule for generating different types of pilot patterns by shifting the basic pilot pattern. In FIG. 9(a), various forms such as a circle, a triangle, a quadrangle, and a pentagon are provided to differentiate each pilot set. Each pilot set is comprised of a pilot for a first antenna or first stream, and a pilot for a second antenna or second stream. Also, the number written in each form expressing each pilot set, for example, “0”, “1”, “2”, “3”, “4”, and “5”, indicates the position-shift order of the pilot sets.

In more detail, a first pilot set 600 positioned at the OFDMA symbol index 0 is shifted from the sub-carrier indexes 0 and 1 to the sub-carrier indexes 4 and 5, and then is again shifted to the sub-carrier indexes 2 and 3.

Also, a second pilot set 602 positioned at the OFDMA symbol index 1 is shifted from the sub-carrier indexes 4 and 5 to the sub-carrier indexes 0 and 1 at the OFDMA symbol index 2, and then is again shifted to the sub-carrier indexes 0 and 1 at the OFDMA symbol index 3.

Also, a third pilot set 604 positioned at the OFDMA symbol index 4 is shifted from the sub-carrier indexes 0 and 1 to the sub-carrier indexes 4 and 5 at the OFDMA symbol index 3, and then is again shifted to the sub-carrier indexes 4 and 5 at the OFDMA symbol index 2.

Also, a fourth pilot set 606 positioned at the OFDMA symbol index 5 is shifted from the sub-carrier indexes 4 and 5 to the sub-carrier indexes 0 and 1, and then is again shifted to the sub-carrier indexes 2 and 3.

As the pilot sets of the basic pilot pattern shown in FIG. 9(b) are shifted according to this rule, it is possible to generate the pilot patterns shown in FIG. 9(c) and FIG. 9(d). The pilot pattern shown in FIG. 9(c) is generated by shifting the pilot sets of the pilot pattern of FIG. 9(b) one time, and the pilot pattern shown in FIG. 9(d) is generated by shifting the pilot sets of the pilot pattern of FIG. 9(b) two times.

In the same manner as the pilot pattern of FIG. 8, a point of starting the change of pilot pattern may be changed in the pilot pattern of FIG. 9 based on at least one criterion.

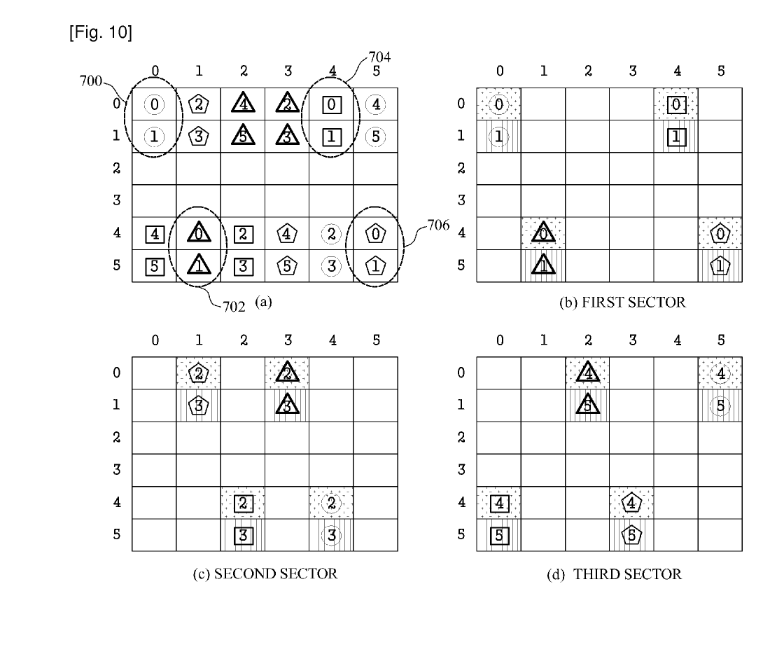

FIG. 10 illustrates a pilot pattern in the resource block of the uplink sub-frame for each sector according to the third embodiment of the present invention.

First, FIG. 10(a) explains a rule for generating different types of pilot patterns by shifting the basic pilot pattern. In FIG. 10(a), various forms such as a circle, a triangle, a quadrangle, and a pentagon are provided to differentiate each pilot set. Each pilot set is comprised of a pilot for a first antenna or first stream, and a pilot for a second antenna or second stream. Also, the number written in each form expressing each pilot set, for example, “0”, “1”, “2”, “3”, “4”, and “5”, indicates the position-shift order of the pilot sets.

In more detail, a first pilot set 700 positioned at the OFDMA symbol index 0 is shifted from the sub-carrier indexes 0 and 1 to the sub-carrier indexes 4 and 5 at the OFDMA symbol index 4, and then is again shifted to the sub-carrier indexes 0 and 1 at the OFDMA symbol index 5.

Also, a second pilot set 702 positioned at the OFDMA symbol index 1 is shifted from the sub-carrier indexes 4 and 5 to the sub-carrier indexes 0 and 1 at the OFDMA symbol index 3, and then is again shifted to the sub-carrier indexes 0 and 1 at the OFDMA symbol index 2.

Also, a third pilot set 704 positioned at the OFDMA symbol index 4 is shifted from the sub-carrier indexes 0 and 1 to the sub-carrier indexes 4 and 5 at the OFDMA symbol index 2, and then is again shifted to the sub-carrier indexes 4 and 5 at the OFDMA symbol index 0.

Also, a fourth pilot set 706 positioned at the OFDMA symbol index 5 is shifted from the sub-carrier indexes 4 and 5 to the sub-carrier indexes 0 and 1 at the OFDMA symbol index 1, and then is again shifted to the sub-carrier indexes 4 and 5 at the OFDMA symbol index 3.

As the pilot sets of the basic pilot pattern shown in FIG. 10(b) are shifted according to this rule, it is possible to generate the pilot patterns shown in FIG. 10(c) and FIG. 10(d). The pilot pattern shown in FIG. 10(c) is generated by shifting the pilot sets of the pilot pattern of FIG. 10(b) one time, and the pilot pattern shown in FIG. 10(d) is generated by shifting the pilot sets of the pilot pattern of FIG. 10(b) two times.

In the same manner as the pilot pattern of FIG. 8, a point of starting the change of pilot pattern may be changed in the pilot pattern of FIG. 10 based on at least one criterion.

In the pilot patterns according to the first to third embodiments of the present invention, it is known that each first pilot set 500, 600, and 700 is arranged at a maximum distance from each fourth pilot set 506, 606, and 706, and each second pilot set 502, 602, and 702 is arranged at a maximum distance from each third pilot set 504, 604, and 704.

The pilot patterns according to the first to third embodiments of the present invention have an advantage over the related art pilot patterns in that the pilot patterns according to the first to third embodiment of the present invention can mitigate interference among the sectors.

A method for calculating a phase of carrier frequency offset (CFO) in the aforementioned embodiments of the present invention is explained through the use of the pilot pattern shown in FIG. 9(d), which can be obtained by adding and averaging phases of CFO shown in the following equation 1.

$$1 ) Phase of C F O = \{ P 4 ( 2 , 0 ) * conj ( P 4 ( 2 , 5 ) ) \} / 5 \\ 2 ) Phase of C F O = \{ ( P 4 ( 2 , 0 ) * conj ( P 4 ( 0 , 3 ) + ( P 4 ( 0 , 3 ) * conj ( P 4 ( 2 , 5 ) ) ) \} / 5 \\ 3 ) Phase of C F O = \{ ( P 4 ( 2 , 0 ) * conj ( P 4 ( 4 , 2 ) + ( P 4 ( 4 , 2 ) * conj ( P 4 ( 2 , 5 ) ) ) \} / 5 \qquad [ Equation 1 ]$$

However, among the pilot patterns according to the first to third embodiments of the present invention, there are the pilot patterns where the pilots for the same antenna are not positioned on the same sub-carrier, or there are the pilot patterns where the difference of symbol index is not uniform on the sub-carrier in which the pilots for the same antenna are positioned. Thus, a channel estimation error is variable so that a channel estimation method has to be changed, thereby causing complexity in channel estimation method.

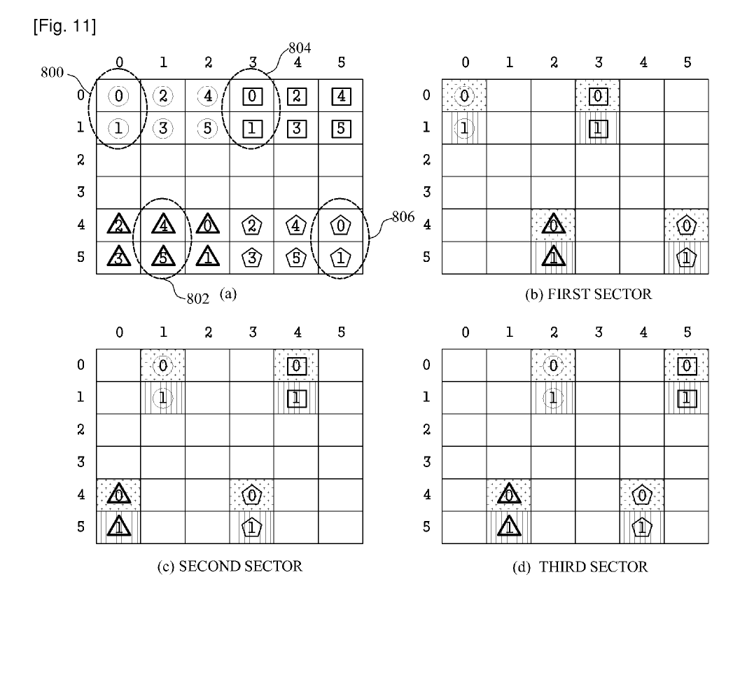

In order to mitigate interference among the sectors and to avoid CFO-computation complexity, a pilot pattern of FIG. 11 has been proposed as follows.

FIG. 11 illustrates a pilot pattern in the resource block of the uplink sub-frame for each sector according to the fourth embodiment of the present invention.

FIG. 11(a) explains a rule for generating different types of pilot patterns by shifting the basic pilot pattern. In FIG. 11(a), various forms such as a circle, a triangle, a quadrangle, and a pentagon are provided to differentiate each pilot set. Each pilot set is comprised of a pilot for a first antenna or first stream, and a pilot for a second antenna or second stream. Also, the number written in each form expressing each pilot set, for example, “0”, “1”, “2”, “3”, “4”, and “5”, indicates the position-shift order of the pilot sets.

In more detail, a first pilot set 800 positioned at the OFDMA symbol index 0 is shifted from the sub-carrier indexes 0 and 1 to the sub-carrier indexes 0 and 1 at the OFDMA symbol index 1, and then is again shifted to the sub-carrier indexes 0 and 1 at the OFDMA symbol index 2.

Also, a second pilot set 802 positioned at the OFDMA symbol index 2 is shifted from the sub-carrier indexes 4 and 5 to the sub-carrier indexes 4 and 5 at the OFDMA symbol 0, and then is again shifted to the sub-carrier indexes 4 and 5 at the OFDMA symbol index 1.

Also, a third pilot set 804 positioned at the OFDMA symbol index 3 is shifted from the sub-carrier indexes 0 and 1 to the sub-carrier indexes 0 and 1 at the OFDMA symbol index 4, and then is again shifted to the sub-carrier indexes 0 and 1 at the OFDMA symbol index 5.

Also, a fourth pilot set 806 positioned at the OFDMA symbol index 5 is shifted from the sub-carrier indexes 4 and 5 to the sub-carrier indexes 4 and 5 at the OFDMA symbol index 3, and then is again shifted to the sub-carrier indexes 4 and 5 at the OFDMA symbol index 4.

In the pilot pattern according to the fourth embodiment of the present invention, a distance between the first and fourth pilot sets 800 and 806 is identical along the symbol axis to a distance between the second and third pilot sets 802 and 804.

In the same manner as the pilot pattern of FIG. 8, a point of starting the change of pilot pattern may be changed in the pilot pattern of FIG. 8 based on at least one criterion.

In case of the pilot pattern according to the fourth embodiment of the present invention, one pilot is allocated by each antenna or each stream within an area corresponding to ¼ of the resource block. This indicates that the pilots are uniformly distributed in resource block.

In the meantime, in case of the pilot pattern according to the fourth embodiment of the present invention, the basic pilot pattern and its modified pilot patterns have the same structural property, so that it is possible to reduce a channel estimation error and a computation complexity. Since two pilots for the same antenna exist in the same subcarrier index, a load for a CFO calculation can be reduced. In the fourth embodiment of the present invention, the CFO calculation can be obtained by adding and averaging phases of CFO shown in the following equation 2.

[Equation 2]

Phase of CFO={P4(0.2)*conj(P4(0.5))}/3 1)

Phase of CFO={P4(4.0)*conj(P4(4.3))}/3 2)

The aforementioned embodiment of the present invention discloses that the pilot pattern shown in each of FIG. 8(b), FIG. 9(b), FIG. 10(b), and FIG. 11(b) is the basic pilot pattern. However, this is only exemplary case. That is, the pilot pattern shown in each of FIG. 8(c), FIG. 9(c), FIG. 10(c), and FIG. 11(c) may be the basic pilot pattern for the first sector; or the pilot pattern shown in each of FIG. 8(d), FIG. 9(d), FIG. 10(d), and FIG. 11(d) may be the basic pilot pattern for the first sector. Also, the pilot pattern shown in each of FIG. 8(d), FIG. 9(d), FIG. 10(d), and FIG. 11(d) may be the pilot pattern for the second sector, and the pilot pattern shown in each of FIG. 8(c), FIG. 9(c), FIG. 10(c), and FIG. 11(c) may be the pilot pattern for the third sector.

A method for pilot signal transmission according to the present invention can be carried out by an apparatus for pilot signal transmission, for example, base station.

In this case, the base station may include a means for generating a transmission frame to be transmitted to a mobile station, and a means for transmitting the transmitting frame to the mobile station.

At this time, the means for generating the transmission frame arranges the pilots and data such that the first pilot pattern for the first cell or first sector is not overlapped with the second pilot pattern for the second cell or sector within at least one resource block included in the transmission frame.

The method for the pilot signal transmission can be realized in type of program command which can be performed through the use of various computer means, and then can be recorded in various computer-readable recording medium.

It will be apparent to those skilled in the art that various modifications and variations can be made in the present invention without departing from the spirit or scope of the inventions.

Thus, it should be understood that the aforementioned embodiments of the present invention are for purpose of illustration, and are not to be constructed as limitations of the invention. It is intended that the present invention covers the modifications and variations of this invention provided they come within the scope of the appended claims and their equivalents.

What is claimed is:

1. A method for a pilot signal transmission comprising:
transmitting an uplink transmission frame for a first sector or cell by a mobile station through the use of basic pilot pattern in a resource block and transmitting an uplink transmission frame for a second sector or cell by the mobile station through the use of shift pilot pattern which is not overlapped with the basic pilot pattern in the resource block.

2. The method of claim 1, wherein the shift pilot pattern is generated by shifting the basic pilot pattern in at least one of symbol index or sub-carrier index directions.

3. The method of claim 1, wherein the basic pilot pattern includes respective pilots for at least two transmission streams.

4. The method of claim 1, wherein the resource block is 6 sub-carriers by 6 symbols.

5. The method of claim 4, wherein the basic pilot pattern is generated such that first pilots are allocated to the 1st and 2nd sub-carriers at the 1st symbol of the resource block, second pilots are allocated to the 5th and 6th sub-carriers at the 2nd symbol, third pilots are allocated to the 1st and 2nd sub-carriers at the 5th symbol, and fourth pilots are allocated to the 5th and 6th sub-carriers at the 6th symbol.

6. The method of claim 5, wherein the shift pilot pattern is generated such that the first pilot is positioned at a maximum distance from the fourth pilot, and the second pilot is positioned at a maximum distance from the third pilot, along both the sub-carrier axis and symbol axis directions in the resource block.

7. The method of claim 4, wherein the basic pilot pattern is generated such that first pilots are allocated to the 1st and 2nd sub-carriers at the 1st symbol of the resource block, second pilots are allocated to the 5th and 6th sub-carriers at the 2nd symbol, third pilots are allocated to the 1st and 2nd sub-carriers at the 4th symbol, and fourth pilots are allocated to the 5th and 6th sub-carriers at the 6th symbol.

8-16. (canceled)

17. A method for a pilot signal transmission comprising:
generating a second pilot pattern while being not overlapped with a first pilot pattern; and
allocating a pilot or pilot set in a downlink sub-frame for a first sector through the use of the first pilot pattern, and allocating a pilot or pilot set in a downlink sub-frame for a second sector through the use of the second pilot pattern.

18. The method of claim 17, wherein the second pilot pattern being not overlapped with the first pilot pattern is generated by cyclically shifting the pilot or pilot set of the first pilot pattern in at least one of the sub-carrier axis and symbol axis directions by a predetermined value in the step of generating the second pilot pattern.

19. The method of claim 17, wherein, when the first and second pilot patterns are used for a macro diversity band, the first and second pilot patterns are applied with the same PRBS.

20. The method of claim 17, wherein, if there are the plurality of second sectors,
a plurality of second pilot patterns are generated while being not overlapped with one another in the step of generating the second pilot pattern; and
the pilot or pilot set is allocated in the downlink sub-frames for the respective second sectors by using the non-overlapped second pilot pattern among the plurality of second pilot patterns in the step of allocating the pilot.

21. The method of claim 17, wherein the pilot or pilot set is allocated by each of at least one resource block included in the downlink sub-frame.

22. The method of claim 21, wherein the resource block is 18 sub-carriers by 6 symbols.

23. The method of claim 21, wherein the second pilot pattern is generated such that:
the first pilot sets are allocated to the 2nd and 11th sub-carriers at the 1st and 2nd symbols, the 8th and 17th sub-carriers at the 3rd and 4th symbols, and the 5th and 14th sub-carriers at the 5th and 6th symbols in the resource block; and
the second pilot sets are allocated to the 8th and 17th sub-carriers at the 1st and 2nd symbols, the 5th and 14th sub-carriers at the 3rd and 4th symbols, and the 2nd and 11th sub-carriers at the 5th and 6th symbols.

24. The method of claim 17, wherein, if the first and second pilot patterns are used in a normal band, the first and second pilot patterns have the different PRBS in the step of generating the second pilot pattern.

25. The method of claim 17, wherein the pilot set includes respective pilots for at least two antennas or transmission streams.

26. The method of claim 17, wherein the second pilot pattern includes first pilot sets for first and second transmission streams or antennas, and second pilot sets for third and fourth transmission streams and antennas, and the position of the second pilot sets is determined by shifting first pilot sets.

27. An apparatus for a pilot signal transmission comprising:
means for forming a transmission frame including at least one resource block whose pilots and data are allocated such that a first pilot pattern for a first cell or sector is not overlapped with a second pilot pattern for a second cell or sector; and
transmission means for transmitting the transmission frame to a mobile station.
